(19) United States
(12) Patent Application Publication
(10) Pub. No.: US 2015/0294826 A1
(43) Pub. Date: Oct. 15, 2015

(54) Complex Protection Component Having Overcurrent Blocking Function and Surge Absorbing Function

(71) Applicant: MS TECHVISION CO., LTD., Ansan-si Gyeonggi-do (KR)

(72) Inventors: Duk Hee Kim, Gyeonggi-do (KR); Ha Young Park, Gangbuk-gu (KR)

(21) Appl. No.: 14/440,197

(22) PCT Filed: Nov. 11, 2013
(86) PCT No.: PCT/KR2013/010185

§ 371 Date: May 1, 2015

(30) Foreign Application Priority Data
Nov. 15, 2012 (KR) 10-2012-0129242

(51) Int. Cl. H01H 85/02; H01H 85/17; H01C 3/20; H01H 85/06

(52) U.S. Cl. CPC H01H 85/0241; H01H 85/06; H01H 85/17; H01C 3/20; H01H 2085/0004

(57) ABSTRACT

Provided is a composite protective component which may enable a device to be stably operated by absorbing external surge such as lightning as well as shutting off an overcurrent, as a component mounted inside various power supply equipment such as mobile phones (cellular phones) or inside a charger. According to the present invention, the composite protective component may be mounted in a power input unit of the various power supply equipment, thereby stably shutting off an overcurrent and absorbing external surge.

### TECHNICAL FIELD

The present invention relates to a composite protective component for shutting off an overcurrent and absorbing surge, and more particularly, a composite protective component which may enable a device to be stably operated by absorbing external surge such as lightning as well as shutting off an overcurrent, as a component mounted inside various power supply equipment such as mobile phones (cellular phones) or inside a charger.

### BACKGROUND ART

In general, accidents are very likely to occur in all of various types of electric/electronic products using electric power since they may be overheated due to an abnormal overcurrent occurring in a circuit therein or external overheating. Conventionally, in order to prevent this problem, a disposable fuse made of a material that is fused and cut off by heat generated when overcurrent flows therethrough is used. Although the disposable fuse is inexpensive, the disposable fuse cannot be reused and should be replaced with a new fuse after the disposable fuse is used, thereby increasing the cost of replacement. To solve this problem, a bimetal thermal switch manufactured by joining different types of metal plates having different thermal expansion coefficients has been used instead of the disposable fuse. However, the bimetal thermal switch simply acts as a contact point, has a high variation in operation rates according to temperature, and requires an additional device, e.g., a limit switch.

Meanwhile, in the latest electronic devices, as surface mounting is performed on a printed circuit board (PCB), a fuse on which surface mounting may be performed is required. However, surface mounting cannot be performed on a conventional disposable fuse since the conventional disposable fuse is fused at a temperature of about 270° C. or more at which soldering is performed during a surface mounting process. Although use of the bimetal thermal switch may avoid this problem, the bimetal thermal switch has a large size and is likely to deteriorate at a soldering temperature. Thus, surface mounting cannot be performed on the bimetal thermal switch either.

To solve this problem, a repeatable fuse made of an elastic member that can be continuously used and on which surface mounting may be performed, e.g., an elastic member made of a shape-memory alloy, has been introduced. The repeatable fuse has high reliability, since power cut-off may be automatically executed and canceled and the elastic member made of a shape-memory alloy has a low temperature deviation.

However, if, under unstable current or voltage circumstances, the repeatable fuse repeatedly performs a process of executing power cut-off and automatically canceling the power cut-off in a state in which a circuit and the like are not sufficiently cooled, then the repeatable fuse may malfunction or circuits included in an electric/electronic product may be overheated. In this case, fire or failure may occur in the electric/electronic product.

### PRIOR ART DOCUMENTS

### Patent Documents

Korean Registered Patent No. 10-1017995

Korean Registered Patent No. 10-0912215

Korean Registered Patent No. 10-1017996

### DISCLOSURE

### Technical Problem

The present invention is directed to a composite protective component which may enable a device to be stably operated by absorbing external surge such as lightning as well as shutting off an overcurrent, as a component mounted inside various power supply equipment such as mobile phones (cellular phones) or a charger.

### Technical Solution

According to an aspect of the present invention, there is provided a composite protective component, including: a fuse resistor including a wire resistor; and a repeatable fuse connected in series with the fuse resistor, wherein the repeatable fuse includes a first lead terminal disposed on one side of a housing having an inner space, an insulation stator configured to fix a part of the first lead terminal while surrounding the part of the first lead terminal, a spindle disposed inside the housing and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle, and wherein a second lead terminal is provided so as to be electrically connected to the wire resistor, and the wire resistor is electrically connected to the housing or the bias spring.

Here, the spindle may have a tack type structure including a rod-like pin which extends lengthwise as a portion connected to the first lead terminal and a plate-like head which is provided at one end of the pin so as to spread widthwise as a portion connected to the bias spring, or a structure including a rod-like pin which extends lengthwise as the portion connected to the first lead terminal and a convex head on which the bias spring is seated.

Also, the main spring may be made of a shape-memory alloy and electrically insulated from the first lead terminal, the bias spring may include a conductive spring, when an overcurrent that is greater than a reference value is applied so that an internal temperature of the housing is higher than a transformation temperature of the shape-memory alloy, the tensile force of the main spring may be greater than a tensile force of the bias spring so that the spindle is moved to separate the first lead terminal and the spindle from each other, and when the positive temperature coefficient thermistor is cooled due to disappearance of a cause of the overcurrent or an external overheat source, the tensile force of the main spring may be smaller than the tensile force of the bias spring so that the spindle is pressurized to be moved in a direction of the first lead terminal by the tensile force of the bias spring.

Also, the housing may be an insulating housing, and the wire resistor may be provided so as to be wound on an outer peripheral surface of the insulating housing.

Also, the wire resistor may be electrically connected to the bias spring through a first conductive capsule, and the first conductive capsule may be disposed so as to seal one side of the insulating housing and further includes an insulating resin that covers the wire resistor.

Also, the fuse resistor and the repeatable fuse may be disposed in parallel to be packaged with an insulating resin, the housing may be a conductive housing or an insulating housing, and the fuse resistor may be electrically connected to the bias spring through a connection terminal or electrically connected to the conductive housing through the connection terminal.

Also, the fuse resistor may include a body, a wire resistor configured to wind around an outer periphery of the body, a first conductive capsule electrically connected to the wire resistor and disposed on one side of the body, and a second conductive capsule electrically connected to the wire resistor and disposed on the other side of the body, wherein the second lead terminal may be disposed on one side of the body and electrically connected to the wire resistor through the second conductive capsule, and the wire resistor may be covered by an insulating resin.

According to another aspect of the present invention, there is provided a composite protective component including: a positive temperature coefficient thermistor; a repeatable fuse disposed in parallel in the positive temperature coefficient thermistor; and a fuse resistor electrically connected in series to the positive temperature coefficient thermistor and the repeatable fuse, wherein the positive temperature coefficient thermistor may include a positive temperature coefficient element formed in a cylinder or tube shape extended in a longitudinal direction while having an inner space, and an electric resistance of which increases when a temperature of the positive temperature coefficient element is higher than a specific critical temperature, a first electrode formed at a first side surface of the positive temperature coefficient element, and a second electrode formed at a second side surface of the positive temperature coefficient element, wherein the repeatable fuse provided inside the positive temperature coefficient element may include a first lead terminal disposed on one side of the positive temperature coefficient element having the inner space, an insulation stator configured to fix a part of the first lead terminal while surrounding the part of the first lead terminal and prevent the first lead terminal from being connected to the positive temperature coefficient element, a spindle disposed in the positive temperature coefficient element and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle, wherein the fuse resistor may include a first conductive capsule electrically connected to the first electrode, a wire resistor electrically connected to the first conductive capsule, and a second conductive capsule electrically connected to the wire resistor, and wherein a second lead terminal may be provided so as to be electrically connected to the wire resistor, when an overcurrent higher than a reference value is applied to the positive temperature coefficient thermistor so that the temperature of the positive temperature coefficient thermistor is higher than the specific critical temperature, the electric resistance of the positive temperature coefficient thermistor may increase, the main spring may expand, and the spindle may be moved by a tensile force of the main spring to be separated from the first lead terminal, so that a current flow between the second lead terminal and the first lead terminal is shut off, and when the overcurrent disappears, the positive temperature coefficient thermistor may be cooled, and the main spring may return to a normal state in such a manner that the spindle is moved to be electrically connected to the first lead terminal due to a reduction in the tensile force of the main spring.

Here, the spindle has a tack type structure including a rod-like pin which extends lengthwise as a portion connected to the first lead terminal and a plate-like head which is provided at one end of the pin so as to spread widthwise as a portion connected to the bias spring, or a structure including a rod-like pin which extends lengthwise as the portion connected to the first lead terminal and a convex head on which the bias spring is seated.

Also, the main spring may be made of a shape-memory alloy and electrically insulated from the first lead terminal, the bias spring may include a conductive spring, when an overcurrent that is greater than a reference value is applied so that an internal temperature of the housing is higher than a transformation temperature of the shape-memory alloy, the tensile force of the main spring may be greater than a tensile force of the bias spring so that the spindle is moved to separate the first lead terminal and the spindle from each other, and when the positive temperature coefficient thermistor is cooled due to disappearance of a cause of the overcurrent or an external overheat source, the tensile force of the main spring may be smaller than the tensile force of the bias spring so that the spindle is pressurized to be moved in a direction of the first lead terminal by the tensile force of the bias spring.

Also, the positive temperature coefficient element may be made of a BaTiO₃-based ceramic material or a polymeric material obtained in such a manner that metal particles having conductivity are distributed within a polymer matrix.

Also, the wire resistor may be provided so as to wind around an outer periphery of an insulating resin that covers the second electrode, and the first conductive capsule may be disposed so as to seal one side of the insulating housing and further includes an insulating resin that covers the wire resistor.

### Advantageous Effects

As described above, according to the embodiments of the present invention, the composite protective component capable of shutting off overcurrent and absorbing surge, which may enable a device to be stably operated by absorbing external surge such as lightning as well as shutting off an overcurrent, can be provided as a component mounted inside various power supply equipment such as mobile phones (cellular phones) or inside a charger.

According to the present invention, the composite protective component may be mounted in the power input unit of the various power supply equipment, thereby stably shutting off the overcurrent and absorbing external surge.

The fuse resistor is responsible for absorption of external surge, and when connecting the repeatable fuse connected in series to the fuse resistor, the repeatable fuse is operated to shut off a circuit when overcurrent is generated, and therefore a surface temperature of the fuse resistor does not rise to a high temperature, thereby stably shutting off an overcurrent.

### DESCRIPTION OF DRAWINGS

FIGS. 1 to 5 are diagrams illustrating a process for manufacturing a composite protective component according to an embodiment of the present invention;

FIG. 6 is an equivalent circuit diagram illustrating the composite protective component shown in FIG. 5;

FIGS. 7 to 9 are diagrams illustrating a process for manufacturing a composite protective component according to another embodiment of the present invention;

FIG. 10 is an equivalent circuit diagram illustrating the composite protective component shown in FIG. 7;

FIGS. 11 to 15 are diagrams illustrating a process for manufacturing a composite protective component according to still another embodiment of the present invention;

FIG. 16 is an equivalent circuit diagram illustrating the composite protective component shown in FIG. 15; and

FIG. 17 is a graph illustrating resistance characteristics in accordance with temperature of a positive temperature coefficient thermistor.

### LIST OF REFERENCE SYMBOLS

100, 200: repeatable fuse
105: housing
110: first lead terminal
120: second lead terminal
130: spindle
140: main spring
150: bias spring
160: insulation stator
205: housing
300: fuse resistor
170, 370: first conductive capsule
180, 380: wire resistor
190, 390: second conductive capsule
700: positive temperature coefficient thermistor
702: first electrode
704: second electrode
706: positive temperature coefficient element

### BEST MODES OF THE INVENTION

According to an aspect of the present invention, there is provided a composite protective component, including: a fuse resistor including a wire resistor; and a repeatable fuse connected in series with the fuse resistor, wherein the repeatable fuse includes a first lead terminal disposed on one side of a housing having an inner space, an insulation stator configured to fix a part of the first lead terminal while surrounding the part of the first lead terminal, a spindle disposed inside the housing and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle, and wherein a second lead terminal is provided so as to be electrically connected to the wire resistor, and the wire resistor is electrically connected to the housing or the bias spring.

According to another aspect of the present invention, there is provided a composite protective component including: a positive temperature coefficient thermistor; a repeatable fuse disposed in parallel in the positive temperature coefficient thermistor; and a fuse resistor electrically connected in series to the positive temperature coefficient thermistor and the repeatable fuse, wherein the positive temperature coefficient thermistor may include a positive temperature coefficient element formed in a cylinder or tube shape extended in a longitudinal direction while having an inner space, and an electric resistance of which increases when a temperature of the positive temperature coefficient element is higher than a specific critical temperature, a first electrode formed at a first side surface of the positive temperature coefficient element, and a second electrode formed at a second side surface of the positive temperature coefficient element, wherein the repeatable fuse provided inside the positive temperature coefficient element may include a first lead terminal disposed on one side of the positive temperature coefficient element having the inner space, an insulation stator configured to fix a part of the first lead terminal while surrounding the part of the first lead terminal and prevent the first lead terminal from being connected to the positive temperature coefficient element, a spindle disposed in the positive temperature coefficient element and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle, wherein the fuse resistor may include a first conductive capsule electrically connected to the first electrode, a wire resistor electrically connected to the first conductive capsule, and a second conductive capsule electrically connected to the wire resistor, and wherein a second lead terminal may be provided so as to be electrically connected to the wire resistor, when an overcurrent higher than a reference value is applied to the positive temperature coefficient thermistor so that the temperature of the positive temperature coefficient thermistor is higher than the specific critical temperature, the electric resistance of the positive temperature coefficient thermistor may increase, the main spring may expand, and the spindle may be moved by a tensile force of the main spring to be separated from the first lead terminal, so that a current flow between the second lead terminal and the first lead terminal is shut off, and when the overcurrent disappears, the positive temperature coefficient thermistor may be cooled, and the main spring may return to a normal state in such a manner that the spindle is moved to be electrically connected to the first lead terminal due to a reduction in the tensile force of the main spring.

### Modes of the Invention

Exemplary embodiments of the present invention will be hereinafter described in detail below with reference to the accompanying drawings. While the present invention is shown and described in connection with exemplary embodiments thereof, it will be apparent to those skilled in the art that various modifications can be made without departing from the spirit and scope of the invention. Like reference numerals denote like elements throughout the drawings.

A composite protective component according to an embodiment of the present invention that can shut off an overcurrent and absorb surge is a component that is mounted inside various power supply equipment such as mobile phones (cellular phones) or inside a charger, and absorbs external surge such as lightning as well as shut off overcurrent so that a device may be stably operated.

In the charger of the mobile phone, a fuse resistor for shutting off the overcurrent or absorbing external surge such as lightning is mounted, but in practice, in an abnormal overcurrent state, winding of the fuse resistor is melted and opened to shut off the overcurrent while the above-described fuse resistor is heated to a high temperature to be red, which is very dangerous due to high temperatures such as 900° C. to 1000° C. or more. In practice, due to such a phenomenon, accidents, small fires, and the like have been reported occasionally in the market.

The composite protective component capable of shutting off an overcurrent and absorbing surge according to an embodiment of the present invention may be mounted in a power input unit of various power supply equipment to stably shut off an overcurrent and absorb external surge.

### FIRST EMBODIMENT

The composite protective component according to a first embodiment of the present invention includes a fuse resistor having a wire resistor and a repeatable fuse connected in series to the fuse resistor. Here, the repeatable fuse includes a first lead terminal disposed on one side of a housing having an inner space, an insulation stator configured to fix a part of the first lead terminal while surrounding the part of the first lead terminal, a spindle disposed inside the housing and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle. Here, a second lead terminal is provided so as to be electrically connected to the wire resistor, and the wire resistor is electrically connected to the housing or the bias spring.

Also, the spindle may have a tack type structure including a rod-like pin which extends lengthwise as a portion connected to the first lead terminal and a plate-like head which is provided at one end of the pin so as to spread widthwise as a portion connected to the bias spring, or a structure including a rod-like pin which extends lengthwise as the portion connected to the first lead terminal and a convex head ( [symbol] ) on which the bias spring is seated.

Also, the main spring may be made of a shape-memory alloy and electrically insulated from the first lead terminal, and the bias spring may include a conductive spring. Also, when an overcurrent that is greater than a reference value is applied so that an internal temperature of the housing is higher than a transformation temperature of the shape-memory alloy, the tensile force of the main spring may be greater than a tensile force of the bias spring so that the spindle is moved to separate the first lead terminal and the spindle from each other, and when the positive temperature coefficient thermistor is cooled due to disappearance of a cause of the overcurrent or an external overheat source, the tensile force of the main spring may be smaller than the tensile force of the bias spring so that the spindle is pressurized to be moved in a direction of the first lead terminal by the tensile force of the bias spring.

The fuse resistor is responsible for absorption of external surge, and when connecting the repeatable fuse connected in series to the fuse resistor, the repeatable fuse is operated to shut off a circuit at generation of overcurrent, and therefore a surface temperature of the fuse resistor does not rise to a high temperature, thereby stably shutting off an overcurrent.

Hereinafter, the composite protective component according to the first embodiment of the present invention will be described in detail.

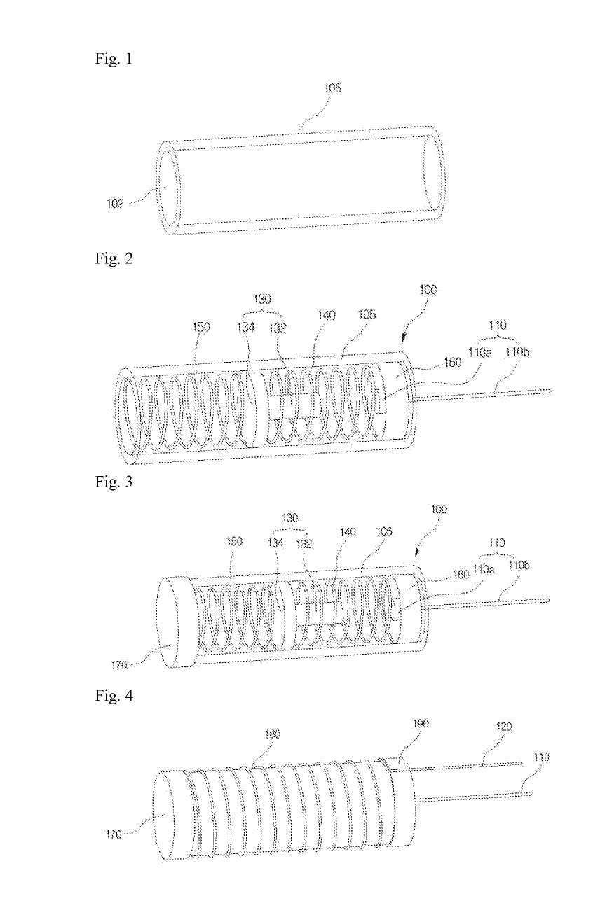

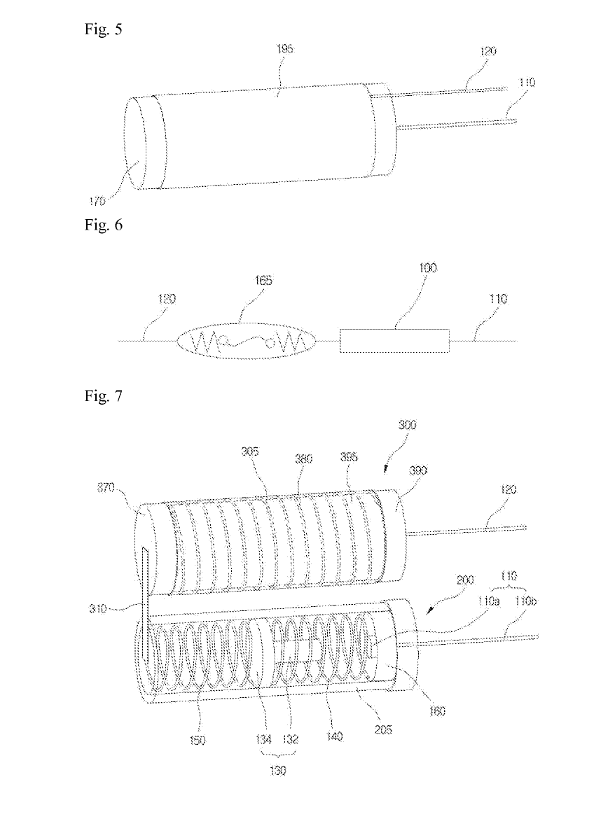

FIGS. 1 to 5 are diagrams illustrating a process for manufacturing a composite protective component according to an embodiment of the present invention, and FIG. 6 is an equivalent circuit diagram illustrating the composite protective component shown in FIG. 5.

Referring to FIGS. 1 to 6, the composite protective component includes a fuse resistor 165 having a wire resistor 180, and a repeatable fuse 100 connected in series to the fuse resistor 165. Here, the repeatable fuse 100 includes a first lead terminal 110 disposed on one side of a housing 105 having an inner space, an insulation stator 160 configured to fix a part of the first lead terminal 110 while surrounding the part of the first lead terminal 110, a spindle 130 disposed inside the housing 105 and electrically connected to a bias spring 150 so as to be electrically connected to or separated from the first lead terminal 110, a main spring 140 provided between the first lead terminal 110 and the spindle 130 so as to separate the first lead terminal 110 and the spindle 130, and a bias spring 150 provided so as to be connected to the spindle 130 on an opposite side of a direction in which the main spring 140 is positioned with respect to the spindle 130 and configured to electrically connect and separate the first lead terminal 110 and the spindle 130. Here, a second lead terminal 120 is provided so as to be electrically connected to the wire resistor 180, and the wire resistor 180 is electrically connected to the housing 105 or the bias spring 150. Also, the housing 105 is an insulating housing, and the wire resistor 180 is provided so as to be wound on an outer peripheral surface of the insulating housing. Also, the wire resistor 180 is electrically connected to the bias spring 150 through a first conductive capsule 170, and the first conductive capsule 170 is disposed so as to seal one side of the insulating housing and further includes an insulating resin 195 that covers the wire resistor 180.

The composite protective component includes the wire resistor 180 formed on an outer peripheral surface of the insulating housing 105 of the repeatable fuse 100, and the wire resistor 180 is connected in series to the repeatable fuse 100.

The composite protective component includes the insulating housing 105 having the inner space, the first lead terminal 110 disposed on one side of the insulating housing 105, the insulation stator 160 configured to fix the part of the first lead terminal 110 while surrounding the part of the first lead terminal 110, the spindle 130 disposed inside the housing 105 and electrically connected to the bias spring 150 so as to be electrically connected to or separated from the first lead terminal 110, the main spring 140 and the bias spring 150 provided inside the insulating housing 105 to be connected to the spindle 130 and configured to electrically connect and separate the first lead terminal 110 and the spindle 130, the wire resistor 180 electrically connected to the bias spring 150 and configured to wind around an outer periphery of the insulating housing 105, and the second lead terminal 120 electrically connected to the wire resistor 180 and disposed on one side of the insulating housing 105.

It is preferable that the wire resistor 180 be electrically connected to the bias spring 150 through the first conductive capsule 170, and the first conductive capsule 170 be disposed so as to seal one side of the insulating housing 105. The first conductive capsule 170 may be electrically connected to the bias spring 150 and made of a conductive material.

The wire resistor 180 may be electrically connected to the first conductive capsule 170. The wire resistor 180 may be provided so as to wind around the outer periphery of the insulating housing 105.

The composite protective component may further include the second conductive capsule 190 that is electrically connected to the wire resistor 180 and is disposed on the other side of the insulating housing 105. In this case, the second conductive capsule 190 may be electrically connected to the second lead terminal 120. In addition, the insulating resin 195 that covers the wire resistor 180 while surrounding the insulating housing 105 may be further included.

The insulating housing 105 is formed in a cylinder or box shape which has an inner space and extends in a longitudinal direction, and receives and protects the spindle 130, the main spring 140, the bias spring 150, and the insulation stator 160 therein.

The insulation stator 160, the first lead terminal 110, the main spring 140, the spindle 130, and the bias spring 150 are inserted and disposed in the insulating housing 105 through an opening 102 formed on one side of the insulating housing 105. An opening through which the first lead terminal 110 passes is formed on the other side of the insulating housing 105. The insulating housing 105 may be made of an insulating material such as alumina (Al₂O₃). The insulating housing 105 may be formed in the shape of a circle, an ellipse, a polygon, or the like at its cross-section perpendicular to the longitudinal direction, and therefore may have various shapes such as a circular box shape, an oval box shape, a polygonal box shape, or the like. In the present embodiment, a cylindrical insulating housing having a circular cross-section perpendicular to the longitudinal direction is illustrated.

The first lead terminal 110 is a means for electrical connection, for example, transmits a current applied from the second lead terminal 120 to an electric/electronic element, and is made of a conductive material. The first lead terminal 110 is provided on one side of the insulating housing 105, and in the present embodiment, is disposed at one end of the cylindrical insulating housing 105. In this instance, the first lead terminal 110 may be disposed so as to be inserted in the insulating housing 105 while passing through one side of the insulating housing 105, but the present invention is not limited thereto, and thus the first lead terminal 110 may be disposed so as to be spaced apart from one side of the insulating housing 105. The first lead terminal 110 may be disposed in any position as long as the spindle 130 can be moved to be connected to or separated from the first lead terminal 110. The first lead terminal 110 may include a head portion 110a that contacts a pin 132 of the spindle 130 and a tail portion 110b that is connected to the head portion 110a. It is preferable that a cross-section of the head portion 110a be formed so as to be wider than a cross-section of the tail portion 110b.

The insulation stator 160 in which the first lead terminal 110 is inserted and fixed is provided inside the insulating housing 105. The insulation stator 160 fixes a part of the first lead terminal 110 which is inserted into the insulating housing 105 while surrounding the part of the first lead terminal 110.

The second lead terminal 120 is a component to which external power is supplied or that is connected to a power source, and includes a conductive material. The second lead terminal 120 is disposed so as to be spaced apart from the first lead terminal 110 by a predetermined distance, but in the present embodiment, the second lead terminal 120 is formed at one end of the cylindrical insulating housing 105 which is positioned in the same direction as one end in which the first lead terminal 100 is formed. The second lead terminal 120 may be electrically connected to the bias spring 150 through the wire resistor 180 and the first conductive capsule 170, and thus may be electrically connected to the spindle 130 again. The main spring 140 and the bias spring 150 are electrically connected to the spindle 130. The second lead terminal 120 is electrically connected to the spindle 130 through the wire resistor 180, the first conductive capsule 170, and the bias spring 150.

The first lead terminal 110 is electrically connected to or disconnected from the second lead terminal 120 through the spindle 130.

The spindle 130 is a means for electrically connecting or disconnecting the first lead terminal 110 and the second lead terminal 120, and is provided inside the insulating housing 105. The spindle 130 may include a pin 132 that contacts the first lead terminal 110 and a head 134 that is connected to the bias spring 150. The spindle 130 may have a tack type structure including the rod-like pin 132 which extends lengthwise as a portion connected to the first lead terminal and a plate-like head 134 which is provided at one end of the pin 132 so as to spread widthwise as a portion connected to the bias spring. In addition, although not shown, the spindle 130 may have a structure including a rod-like pin which extends lengthwise as the portion connected to the first lead terminal 110 and a convex head ( [symbol] ) on which the bias spring 150 is seated as the portion connected to the bias spring 150. The spindle 130 may be electrically connected to or separated from the first lead terminal 110, and made of a conductive material. The spindle 130 may be electrically connected to or separated from the first lead terminal 110, that is, electrically connected to or disconnected from the first lead terminal 110 while reciprocating the inside of the insulating housing 105 in the longitudinal direction by the expanding/contracting motion of the main spring 140 and the bias spring 150. Thus, the spindle 130 is connected to or separated from the first lead terminal 110, and therefore the first lead terminal 110 and the second lead terminal 120 are electrically connected to or disconnected from each other.

Each of the main spring 140 and the bias spring 150 is a means for connecting or separating the first lead terminal 110 and the spindle 130. The main spring 140 and the bias spring 150 are disposed inside the insulating housing 105, and extended or compressed in the longitudinal direction of the insulating housing 105. The main spring 140 is disposed on one inner side of the insulating housing 105, and in the present embodiment, the main spring 140 is connected to the insulation stator 160 within the insulating housing 105. The bias spring 150 is disposed on the other inner side of the insulating housing 105 that is an opposite side of the side on which the main spring 140 is disposed with respect to the spindle 130, and is electrically connected to the spindle.

Specifically, the main spring 140 is used to separate the first lead terminal 110 and the spindle 130, and provided between the first lead terminal 110 and the spindle 130. In this instance, the main spring 140 is provided on one side of the spindle 130, and preferably provided between the insulation stator 160 and the spindle 130. The main spring 140 may be positioned between the insulation stator 160 and the spindle 130 in a compressed state. That is, in the composite protective component according to the present embodiment, when the main spring 140 is compressed, the first lead terminal 110 and the spindle 130 contact each other, and when the main spring 140 is extended, the first lead terminal 110 and the spindle 130 are separated from each other. In addition, for this, in the present invention, the main spring 140 may be made of a shape-memory alloy having properties in which the alloy is transformed at a temperature less than a transformation temperature and returns to a shape before the transformation at the transformation temperature or higher, and may be extended when the compressed main spring 140 is heated. Such a main spring 140 may be made of nitinol, which is an alloy of titanium (Ti) and nickel (Ni), or an alloy of copper (Cu)/zinc (Zn)/aluminum (Al). It is preferable that such a main spring 140 be electrically insulated from the first lead terminal 110 and electrically connected to the spindle 130.

The bias spring 150 is used for electrically connecting or separating the first lead terminal 110 and the spindle 130 together with the main spring 140, and may be provided so as to be connected to the spindle 130 on an opposite side of a direction in which the main spring 140 is positioned with respect to the spindle 130. In this instance, the bias spring 150 may be made of a general metal material such as stainless steel rather than the shape-memory alloy unlike the main spring 140. For example, stainless steel may be used as a main body of the bias spring 150, and silver film plating may be carried out on the main body. That is, the bias spring 150 requires an arbitrary spring tensile force, and silver film plating with a predetermined thickness is carried out on the bias spring 150 in order to help a current flow. At a constant voltage and current, a stable current flows due to conductivity of a metal itself and the silver film plating and a temperature of the bias spring 150 rises when overvoltage or overcurrent is applied. In this manner, the bias spring 150 is provided in an extended state in the same manner as a general spring, applies pressure so as to maintain connection between the spindle 130 and the first lead terminal 110, and is compressed when the main spring 140 is extended, so that the first lead terminal 110 and the spindle 130 may be separated from each other.

In the composite protective component having the above-described structure, when a normal current or voltage equal to or less than a reference value is applied to the first lead terminal 110 and the second lead terminal 120, the bias spring 150 is in an extended state, and the main spring 140 is kept compressed by a tensile force of the extended bias spring 150. Thus, the first lead terminal 110 is brought into contact with the pin 132 of the spindle 130, and is electrically connected to the second lead terminal 120 through the bias spring 150 that contacts the head 134 of the spindle 130, the first conductive capsule 170 that contacts the bias spring 150, and the wire resistor 180 that contacts the first conductive capsule 170.

In the composite protective component according to the present embodiment of the present invention, when abnormal power, for example, a current or a voltage higher than a reference value, is applied to the first lead terminal 110 and the second lead terminal 120, a high current is applied to the bias spring 150. When a high current is applied to the bias spring 150, a temperature of the bias spring 150 rises by a resistance value of the bias spring 150, and therefore a temperature of the inside of the insulating housing 105 rises. In addition, the main spring 140 made of the shape-memory alloy may be transformed into a shape of the main spring 140 extended in accordance with a rising temperature due to abnormal overheating of electric heating equipment or electrical equipment. When the main spring 140 is transformed into the extended shape, the spindle 130 is pressurized in a direction in which the bias spring 150 is positioned by a tensile force of the main spring 140, and therefore the bias spring 150 is compressed. In addition, when the main spring 140 is extended in this manner, the first lead terminal and the spindle 130 are separated from each other by the movement of the spindle 130, and consequently, the first lead terminal 110 and the second lead terminal 120 are electrically disconnected from each other, whereby a current between the first lead terminal 110 and the second lead terminal 120 does not flow. In this instance, for this operation, it is preferable that the tensile force of the main spring 140 below the transformation (transition) temperature be smaller than the tensile force of the bias spring 150, and the tensile force of the main spring 140 equal to or higher than the transformation (transition) temperature be greater than of the tensile force of the bias spring 150.

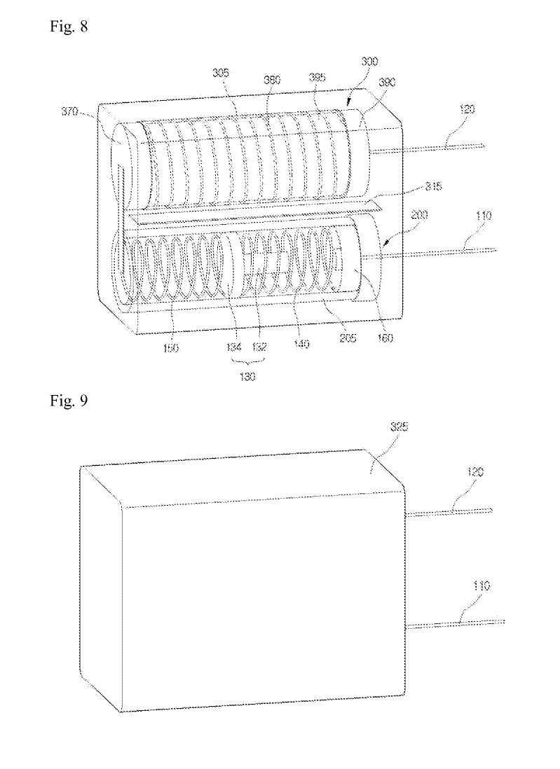

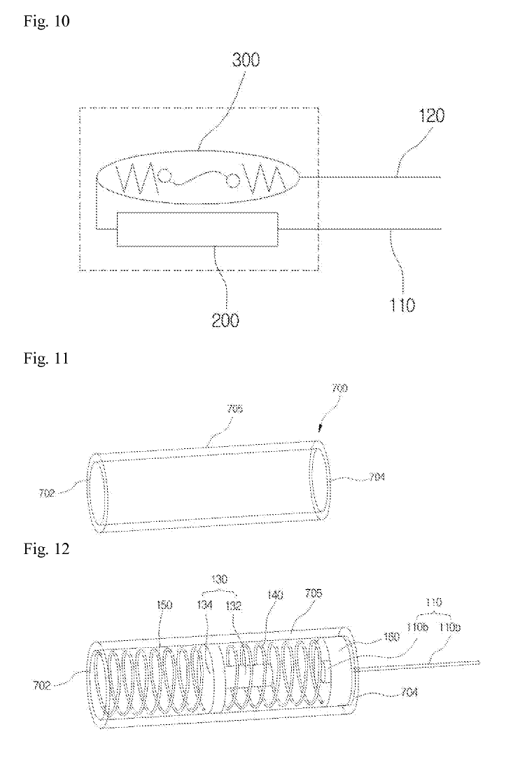

FIGS. 7 to 9 are diagrams illustrating a process for manufacturing a composite protective component according to another embodiment of the present invention, and FIG. 10 is an equivalent circuit diagram illustrating the composite protective component shown in FIG. 7.

Referring to FIGS. 7 to 10, the composite protective component according to the present embodiment includes a fuse resistor 300 having a wire resistor and a repeatable fuse 200 connected in series to the fuse resistor. Here, the repeatable fuse 200 includes a first lead terminal 110 disposed on one side of a housing 205 having an inner space, an insulation stator 160 configured to fix a part of the first lead terminal 110 while surrounding the part of the first lead terminal 110, a spindle 130 disposed inside the housing 205 and electrically connected to a bias spring 150 so as to be electrically connected to or separated from the first lead terminal 110, a main spring 140 provided between the first lead terminal 110 and the spindle 130 so as to separate the first lead terminal 110 and the spindle 130, and a bias spring 150 provided so as to be connected to the spindle 130 on an opposite side of a direction in which the main spring 140 is positioned with respect to the spindle 130 and configured to electrically connect and separate the first lead terminal 110 and the spindle 130. Here, a second lead terminal 120 is provided so as to be electrically connected to the wire resistor 380, and the wire resistor 380 is electrically connected to the housing 205 or the bias spring 150. Also, the fuse resistor 300 and the repeatable fuse 200 are disposed in parallel to be packaged with an insulating resin 325, the housing 205 is a conductive housing or an insulating housing, and the fuse resistor 300 is electrically connected to the bias spring 150 through a connection terminal 310 or electrically connected to the housing 205 through the connection terminal 310.

The fuse resistor includes a body 305, the wire resistor 380 configured to wind around an outer periphery of the body 305, a first conductive capsule 370 electrically connected to the wire resistor 380 and disposed on one side of the body 305, and a second conductive capsule 390 electrically connected to the wire resistor 380 and disposed on the other side of the body 305. Here, the second lead terminal 120 may be disposed on one side of the body 305 and electrically connected to the wire resistor 380 through the second conductive capsule 390, and the wire resistor 380 may be covered by an insulating resin 395.

In the composite protective component according to the present embodiment, the fuse resistor 300 and the repeatable fuse 200, which are independently manufactured, are disposed in parallel to be connected in series to each other, and are packaged with an insulating resin.

The composite protective component according to the present embodiment includes the repeatable fuse 200 and the fuse resistor 300.

The repeatable fuse 200 includes the housing 205 having an inner space, the first lead terminal 110 disposed on one side of the housing 205, the insulation stator 160 configured to fix a part of the first lead terminal 110 while surrounding the part of the first lead terminal 110 and suppress connection between the housing 205 and the first lead terminal 110, the spindle 130 disposed inside the housing 205 and electrically connected to the bias spring 150 so as to be electrically connected to or separated from the first lead terminal 110, and the main spring 140 and the bias spring 150 which are elastic members provided inside the housing 205 to be connected to the spindle 130 and configured to electrically connect and separate the first lead terminal 110 and the spindle 130.

The fuse resistor 300 may be electrically connected to the bias spring 150 through the connection terminal 310, or electrically connected to the housing 205 through the connection terminal 310. The fuse resistor 300 includes the body 305, the wire resistor 380 configured to wind around an outer periphery of the body 305, the first conductive capsule 370 electrically connected to the wire resistor 380 and disposed on one side of the body 305, and the second conductive capsule 390 electrically connected to the wire resistor 380 and disposed on the other side of the body 305, and the second lead terminal 120 electrically connected to the second conductive capsule 390 and disposed on one side of the body 305. The wire resistor 380 of the fuse resistor 300 may be covered by an insulating resin 395.

The housing 205 is formed in a cylinder or box shape which has an inner space and extends in a longitudinal direction, and receives and protects the spindle 130, the main spring 140, the bias spring 150, and the insulation stator 160 therein. The insulation stator 160, the first lead terminal 110, the main spring 140, the spindle 130, and the bias spring 150 are inserted in the housing 205 through an opening formed on one side of the housing 205 to be disposed. An opening through which the first lead terminal 110 passes is formed on the other side of the housing 205. The housing 205 may be made of an electrically conductive material such as a metal, or an insulator such as alumina (Al₂O₃). The housing 205 may be formed in the shape of a circle, an ellipse, a polygon, or the like at its cross-section perpendicular to the longitudinal direction, and therefore may have various shapes such as a circular box shape, an oval box shape, a polygonal box shape, or the like. In the present embodiment, a cylindrical conductive housing having a circular cross-section perpendicular to the longitudinal direction is illustrated.

The first lead terminal 110 is provided on one side of the housing 205, and in the present embodiment, is disposed at one end of the cylindrical housing 205. In this instance, the first lead terminal 110 may be disposed to penetrate the one side of the housing 205, but the present invention is not limited thereto, and thus the first lead terminal 110 may be disposed so as to be spaced apart from one side of the housing 105. The first lead terminal 110 may be disposed in any position as long as the spindle 130 can be moved to be connected to or separated from the first lead terminal 110. The insulation stator 160 through which the first lead terminal 110 is inserted and fixed is provided inside the housing 205. The insulation stator 160 fixes a part of the first lead terminal 110 inserted in the housing 205 while surrounding the part of the first lead terminal 110.

The second lead terminal 120 is disposed so as to be spaced apart from the first lead terminal 110 by a predetermined distance, and in the present embodiment, the second lead terminal 120 is formed at one end of the fuse resistor 300 positioned in the same direction as one end in which the first lead terminal 110 is formed. The second lead terminal 120 may be electrically connected to the bias spring 150 through the wire resistor 380 and the first conductive capsule 370 or electrically connected to the housing 205 (a case in which the housing 205 is formed of a conductive housing), and thus may be electrically connected to the spindle 130 again. The main spring 140 and the bias spring 150 are connected to the spindle 130 to be electrically connected to each other. The second lead terminal 120 may be electrically connected to the spindle 130 through the second conductive capsule 390, the wire resistor 180, the first conductive capsule 370, the connection terminal 310, and the bias spring 150.

The spindle 130 is a means for electrically connecting or disconnecting the first lead terminal 110 and the second lead terminal 120, and is provided inside the housing 205. The spindle 130 may be electrically connected to or separated from the first lead terminal 110, that is, electrically connected to or disconnected from the first lead terminal 110 while reciprocating the inside of the housing 105 in the longitudinal direction by the expanding/contracting motion of the main spring 140 and the bias spring 150. The main spring 140 and the bias spring 150 are disposed inside the housing 205 so as to be extended or compressed in the longitudinal direction of the housing 205. The main spring is disposed on one inner side of the housing 205, and in the present embodiment, is connected to the insulation stator 160 inside the housing 205. The bias spring 150 is disposed on the other inner side of the housing 205 that is an opposite side of a side in which the main spring 140 is disposed with respect to the spindle 130, and electrically connected to the spindle 130.

In the composite protective component, the repeatable fuse 200 and the fuse resistor 300 which are independently manufactured are disposed in parallel to be connected in series to each other, and the repeatable fuse 200 and the fuse resistor 300 which are disposed in parallel are subjected to packaging (molding) with an insulating resin 325. Before performing packaging (molding) using the insulating resin 325, a thermally conductive material 315 with excellent thermal conductivity such as epoxy or copper (Cu) may be inserted between the repeatable fuse 200 and the fuse resistor 300 for the purpose of smooth thermal synchronization.

In the above-described embodiments, the case in which the main spring 140 is made of the shape-memory alloy has been described, but the bias spring 150 may be made of the shape-memory alloy and the main spring 140 may be made of a general metal material such as stainless steel rather than the shape-memory alloy material.

Meanwhile, in the present embodiment, the coil-like main spring 140 and the bias spring 150 are used as elastic members to form the composite protective component, but the present invention is not limited thereto, and thus the main spring 140 or/and the bias spring 150 may be a spring formed in a shape other than the coil such as a flat spring.

In the above-described embodiments, a power source is connected to the second lead terminal 120, and an electric/electronic device such as a circuit is connected to the first lead terminal 110, but the power source may be connected to the first lead terminal 110 and the electric/electronic device may be connected to the second lead terminal 120.

### SECOND EMBODIMENT

The composite protective component according to a second embodiment of the present invention includes a positive temperature coefficient thermistor, a repeatable fuse disposed in parallel in the positive temperature coefficient thermistor, and a fuse resistor electrically connected in series to the positive temperature coefficient thermistor and the repeatable fuse. Here, the positive temperature coefficient thermistor includes a positive temperature coefficient element formed in a cylinder or tube shape extended in a longitudinal direction while having an inner space, and an electric resistance of which increases when a temperature of the positive temperature coefficient element is higher than a specific critical temperature, a first electrode formed at a first side surface of the positive temperature coefficient element, and a second electrode formed at a second side surface of the positive temperature coefficient element. Also, the repeatable fuse provided inside the positive temperature coefficient element includes a first lead terminal disposed on one side of the positive temperature coefficient element having the inner space, an insulation stator configured to fix a part of the first lead terminal while surrounding the part of the first lead terminal and prevent the first lead terminal from being connected to the positive temperature coefficient element, a spindle disposed in the positive temperature coefficient element and electrically connected to a bias spring so as to be electrically connected to or separated from the first lead terminal, a main spring provided between the first lead terminal and the spindle so as to separate the first lead terminal and the spindle, and a bias spring provided so as to be connected to the spindle on an opposite side of a direction in which the main spring is positioned with respect to the spindle and configured to electrically connect and separate the first lead terminal and the spindle. Also, the fuse resistor includes a first conductive capsule electrically connected to the first electrode, a wire resistor electrically connected to the first conductive capsule, and a second conductive capsule electrically connected to the wire resistor. Also, a second lead terminal is provided so as to be electrically connected to the wire resistor, when an overcurrent higher than a reference value is applied to the positive temperature coefficient thermistor so that the temperature of the positive temperature coefficient thermistor is higher than the specific critical temperature, the electric resistance of the positive temperature coefficient thermistor increases, the main spring expands, and the spindle is moved by a tensile force of the main spring to be separated from the first lead terminal, so that a current flow between the second lead terminal and the first lead terminal is shut off, and when the overcurrent disappears, the positive temperature coefficient thermistor is cooled, and the main spring returns to a normal state in such a manner that the spindle is moved to be electrically connected to the first lead terminal due to a reduction in the tensile force of the main spring.

In addition, although not shown, the spindle 130 may have a structure including a rod-like pin which extends lengthwise as the portion connected to the first lead terminal 110 and a convex head ( [symbol] ) on which the bias spring 150 is seated.

The main spring may be made of a shape-memory alloy and electrically insulated from the first lead terminal, and the bias spring may include a conductive spring. Also, when an overcurrent that is greater than a reference value is applied so that an internal temperature of the housing is higher than a transformation temperature of the shape-memory alloy, the tensile force of the main spring may be greater than a tensile force of the bias spring so that the spindle is moved to separate the first lead terminal and the spindle from each other, and when the positive temperature coefficient thermistor is cooled due to disappearance of a cause of the overcurrent or an external overheat source, the tensile force of the main spring may be smaller than the tensile force of the bias spring so that the spindle is pressurized to be moved in a direction of the first lead terminal by the tensile force of the bias spring.

The positive temperature coefficient element may be made of a BaTiO₃-based ceramic material or a polymeric material obtained in such a manner that metal particles having conductivity are distributed within a polymer matrix.

The wire resistor may be provided so as to wind around an outer periphery of an insulating resin that covers the second electrode, and the first conductive capsule may be disposed so as to seal one side of the insulating housing and further include an insulating resin that covers the wire resistor.

Hereinafter, the composite protective component according to the second embodiment of the present invention will be described in detail.

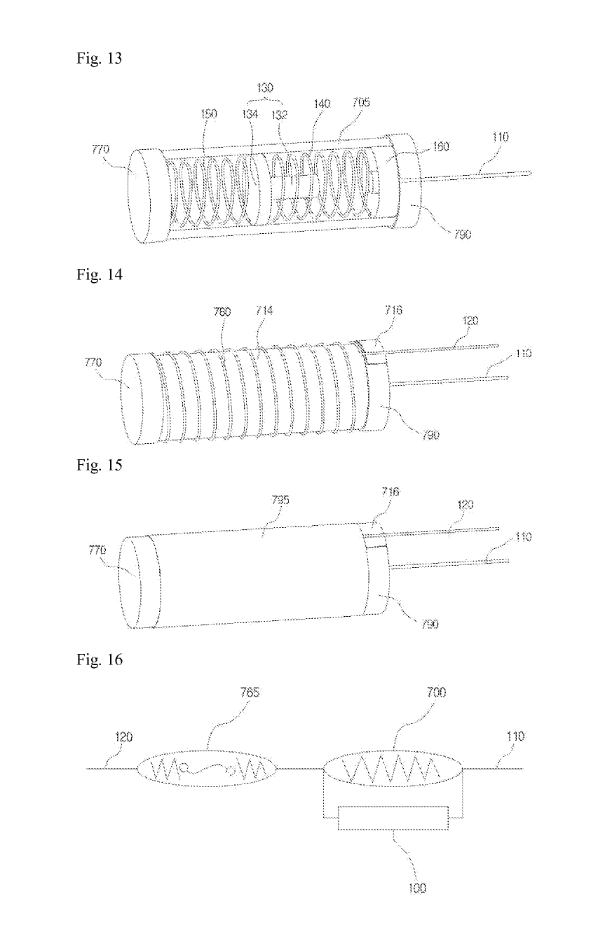

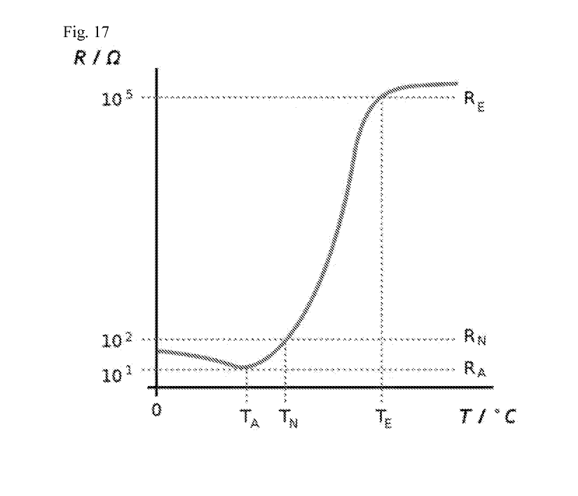

FIGS. 11 to 15 are diagrams illustrating a process for manufacturing a composite protective component according to still another embodiment of the present invention, and FIG. 16 is an equivalent circuit diagram illustrating the composite protective component shown in FIG. 15.

Referring to FIGS. 11 to 16, the composite protective component according to the second embodiment of the present invention may be manufactured in such a manner that a positive temperature coefficient thermistor 700 is implemented, a repeatable fuse structure inside the positive temperature coefficient thermistor 700 is assembled to implement a repeatable fuse 100, a terminal process is performed on the repeatable fuse 100 so as to be electrically connected to the positive temperature coefficient thermistor 700, the wire resistor 780 is wound around the positive temperature coefficient thermistor 700 in order to form the fuse resistor 765 after performing an insulating process on the positive temperature coefficient thermistor 700, the fuse resistor 765 is electrically connected in series to the positive temperature coefficient thermistor 700 and the repeatable fuse 200, and a molding process is performed using an insulating resin such as epoxy as an external protective film.

The positive temperature coefficient thermistor 700 includes a positive temperature coefficient element 706 formed in a cylinder or tube shape extended in a longitudinal direction while having an inner space, and an electric resistance of which increases when a temperature of the positive temperature coefficient element 706 is higher than a specific critical temperature, a first electrode 702 formed at a first side surface of the positive temperature coefficient element, and a second electrode 704 formed at a second side surface of the positive temperature coefficient element 706.

An insulating process such as coating or depositing an insulator 714 on an outer periphery surface of the positive temperature coefficient element 706 is performed in order to prevent short between both electrodes 702 and 704 of the positive temperature coefficient thermistor 700 and connection with the wire resistor 380.

The repeatable fuse 100 is provided inside the positive temperature coefficient element 706.

The wire resistor 780 is provided so as to be wound on the insulator 714 that wraps the positive temperature coefficient thermistor 700, and is configured to be connected in series to the positive temperature coefficient thermistor 700 and the repeatable fuse 100.

The repeatable fuse 100 provided inside the positive temperature coefficient element 706 includes a first lead terminal 110 disposed on one side of the positive temperature coefficient element 706 having the inner space, an insulation stator 160 configured to fix a part of the first lead terminal 110 while surrounding the part of the first lead terminal 110, a spindle 130 disposed inside the positive temperature coefficient element 706 and electrically connected to a bias spring 150 so as to be electrically connected to or separated from the first lead terminal 110, and a main spring 140 and a bias spring 150 which are elastic members provided inside the positive temperature coefficient element 706 to be connected to the spindle 130 and configured to electrically connect and separate the first lead terminal 110 and the spindle 130.

The composite protective component according to the second embodiment of the present invention includes a first conductive capsule 770 electrically connected to the bias spring 150, the wire resistor 780 configured to wind the insulator 714 coated around an outer periphery of the positive temperature coefficient element 706 and electrically connected to the first conductive capsule 770, and the second lead terminal electrically connected to the wire resistor 780 and disposed on one side of the positive temperature coefficient element 706.

It is preferable that the wire resistor 780 be electrically connected to the bias spring 150 through the first conductive capsule 770 and the first conductive capsule 770 be disposed so as to seal one side of the positive temperature coefficient element 706. The first conductive capsule 770 is made of a conductive material so as to be electrically connected to the bias spring 150.

The wire resistor 780 may be electrically connected to the first conductive capsule 770. The wire resistor 780 may be provided so as to wind the insulator 714 coated around the outer periphery of the positive temperature coefficient element 706.

The composite protective component according to the second embodiment of the present invention may further include a second conductive capsule 790 disposed on the other side of the positive temperature coefficient element 706. When connecting the second lead terminal 120 to the wire resistor 780, it is preferable that the insulator 716 be provided between the second lead terminal 120 and the second conductive capsule 790. In addition, an insulating resin 795 that covers the wire resistor 780 while surrounding the positive temperature coefficient element 706 may be further included.

The positive temperature coefficient element 706 is formed in a cylinder or box shape which has an inner space and extends in the longitudinal direction, and receives and protects the spindle 130, the main spring 140, the bias spring 150, and the insulation stator 160 therein. The insulation stator 160, the first lead terminal 110, the main spring 140, the spindle 130, and the bias spring 150 are inserted and disposed through an opening formed on one side of the positive temperature coefficient element 706. The positive temperature coefficient element 706 may be formed in the shape of a circle, an ellipse, a polygon, or the like at its cross-section perpendicular to the longitudinal direction, and therefore may have various shapes such as a circular box shape, an oval box shape, a polygonal box shape, or the like. In the present embodiment, a cylindrical insulating housing having a circular cross-section perpendicular to the longitudinal direction is illustrated.

The first lead terminal 110 is a means for electrical connection that, for example, transmits a current applied from the second lead terminal 120 to an electric/electronic element, and is made of a conductive material. The first lead terminal 110 is provided on one side of the positive temperature coefficient element 706, and in the present embodiment, is disposed at one end of the cylindrical positive temperature coefficient element 706.

In this instance, the first lead terminal 110 may be disposed so as to be inserted into the insulating housing 105 while passing through one side of the positive temperature coefficient element 706, but the first lead terminal 110 may be disposed in any position as long as the spindle 130 can be moved to be connected to or separated from the first lead terminal 110. The first lead terminal 110 may include a head portion 110a that contacts a pin 132 of the spindle 130 and a tail portion 110b that is connected to the head portion 110a. It is preferable that a cross-section of the head portion 110a be formed so as to be wider than a cross-section of the tail portion 110b.

The insulation stator 160 in which the first lead terminal 110 is inserted and fixed is provided inside the positive temperature coefficient element 706. The insulation stator 160 fixes a part of the first lead terminal 110 which is inserted in the insulating housing 105 while surrounding the part of the first lead terminal 110.

The second lead terminal 120 is a component to which external power is applied or that is connected to a power source, and includes a conductive material. The second lead terminal 120 is disposed so as to be spaced apart from the first lead terminal 110 by a predetermined distance, but in the present embodiment, the second lead terminal 120 is formed at one end of the positive temperature coefficient element 706 positioned in the same direction as one end in which the first lead terminal 110 is formed. The second lead terminal 120 may be electrically connected to the bias spring 150 through the wire resistor 780 and the first conductive capsule 770, and thus may be electrically connected to the spindle 130. The main spring 140 and the bias spring 150 are electrically connected to the spindle 130. The second lead terminal 120 is electrically connected to the spindle 130 through the wire resistor 780, the first conductive capsule 770, and the bias spring 150.

The first lead terminal 110 is electrically connected to or disconnected from the second lead terminal 120 through the spindle 130.

The spindle 130 is a means for electrically connecting or disconnecting the first lead terminal 110 and the second lead terminal 120, and is provided inside the positive temperature coefficient element 706. The spindle 130 may include a pin 132 that contacts the first lead terminal 110 and a head 134 that is connected to the bias spring 150. The spindle 130 may have a tack type structure including the rod-like pin 132 which extends lengthwise as a portion connected to the first lead terminal and a plate-like head 134 which is provided at one end of the pin 132 so as to spread widthwise. In addition, although not shown, the spindle 130 may have a structure including a rod-like pin which extends lengthwise as the portion connected to the first lead terminal 110 and a convex head ( [symbol] ) on which the bias spring 150 is seated as the portion connected to the bias spring 150. The spindle 130 may be electrically connected to or separated from the first lead terminal 110, and made of a conductive material. The spindle 130 may be electrically connected to or separated from the first lead terminal 110, that is, electrically connected to or disconnected from the first lead terminal 110 while reciprocating the inside of the positive temperature coefficient element 706 in the longitudinal direction by the expanding/contracting motion of the main spring 140 and the bias spring 150. Thus, the spindle 130 is connected to or separated from the first lead terminal 110, and therefore the first lead terminal 110 and the second lead terminal 120 are electrically connected to or disconnected from each other.

Each of the main spring 140 and the bias spring 150 is a means for connecting or separating the first lead terminal 110 and the spindle 130. The main spring 140 and the bias spring 150 are disposed inside the positive temperature coefficient element 706, and extended or compressed in the longitudinal direction of the positive temperature coefficient element 706. The main spring 140 is disposed on one inner side of the positive temperature coefficient element 706, and in the present embodiment, the main spring 140 is connected to the insulation stator 160 within the positive temperature coefficient element 706. The bias spring 150 is disposed on the other inner side of the positive temperature coefficient element 706 that is an opposite side of the side on which the main spring 140 is disposed with respect to the spindle 130, and is electrically connected to the spindle.

Specifically, the main spring 140 is used to separate the first lead terminal 110 and the spindle 130, and provided between the first lead terminal 110 and the spindle 130. In this instance, it is preferable that the main spring 140 be provided on one side of the spindle 130, and provided between the insulation stator 160 and the spindle 130. The main spring 140 may be positioned between the insulation stator 160 and the spindle 130 in a compressed state. That is, in the composite protective component according to the present embodiment, when the main spring 140 is compressed, the first lead terminal 110 and the spindle 130 contact each other, and when the main spring 140 is extended, the first lead terminal 110 and the spindle 130 are separated from each other. In addition, for this, in the present invention, the main spring 140 may be made of a shape-memory alloy having properties in which the alloy is transformed at a temperature less than a transformation temperature and returns to a shape before the transformation at the transformation temperature or higher, and may be extended when the compressed main spring 140 is heated. Such a main spring 140 may be made of nitinol, which is an alloy of titanium (Ti) and nickel (Ni), or an alloy of copper (Cu)/zinc (Zn)/aluminum (Al). It is preferable that such a main spring 140 be electrically insulated from the first lead terminal 110 and electrically connected to the spindle 130.

The bias spring 150 is used for electrically connecting or separating the first lead terminal 110 and the spindle 130 together with the main spring 140, and may be provided so as to be connected to the spindle 130 on an opposite side of a direction in which the main spring 140 is positioned with respect to the spindle 130. In this instance, the bias spring 150 may be made of a general metal material such as stainless steel rather than the shape-memory alloy unlike the main spring 140. For example, stainless steel may be used as a main body of the bias spring 150, and silver film plating may be carried out on the main body. That is, the bias spring 150 requires an arbitrary spring tensile force, and silver film plating with a predetermined thickness is carried out on the bias spring 150 in order to help a current flow. At a constant voltage and current, a stable current flows due to conductivity of a metal itself and the silver film plating and a temperature of the bias spring 150 rises when overvoltage or overcurrent is applied. In this manner, the bias spring 150 is provided in an extended state in the same manner as a general spring, applies pressure so as to maintain connection between the spindle 130 and the first lead terminal 110, and is compressed when the main spring 140 is extended, so that the first lead terminal 110 and the spindle 130 may be separated from each other.

In the composite protective component having the above-described structure, when a normal current or voltage equal to or less than a reference value is applied to the first lead terminal 110 and the second lead terminal 120, the bias spring 150 is in an extended state, and the main spring 140 is kept compressed by a tensile force of the extended bias spring 150. Thus, the first lead terminal 110 is brought into contact with the pin 132 of the spindle 130, and is electrically connected to the second lead terminal 120 through the bias spring 150 that contacts the head 134 of the spindle 130, the first conductive capsule 170 that contacts the bias spring 150, and the wire resistor 180 that contacts the first conductive capsule 170.

In the composite protective component according to the second embodiment of the present invention, when abnormal power, for example, a current or a voltage higher than a reference value, is applied to the first lead terminal 110 and the second lead terminal 120, a high current is applied to the bias spring 150. When a high current is applied to the bias spring 150, a temperature of the bias spring 150 rises by a resistance value of the bias spring 150, and therefore a temperature of the inside of the positive temperature coefficient element 706 rises. In addition, the main spring 140 made of the shape-memory alloy may be transformed into a shape of the main spring 140 extended in accordance with a rising temperature due to abnormal overheating of electric heating equipment or electrical equipment. When the main spring 140 is transformed into the extended shape, the spindle 130 is pressurized in a direction in which the bias spring 150 is positioned by a tensile force of the main spring 140, and therefore the bias spring 150 is compressed. In addition, when the main spring 140 is extended in this manner, the first lead terminal and the spindle 130 are separated from each other by the movement of the spindle 130, and consequently, the first lead terminal 110 and the second lead terminal 120 are electrically disconnected from each other, causing a current between the first lead terminal 110 and the second lead terminal 120 not to flow. In this instance, for this operation, it is preferable that the tensile force of the main spring 140 below the transformation (transition) temperature be smaller than the tensile force of the bias spring 150, and the tensile force of the main spring 140 equal to or higher than the transformation (transition) temperature be greater than of the tensile force of the bias spring 150.

In the above-described embodiment, a case in which the main spring 140 is made of the shape-memory alloy has been described, but the bias spring 150 may be made of the shape-memory alloy and the main spring 140 may be made of a general metal material such as stainless steel rather than the shape-memory alloy material.

Meanwhile, in the present embodiment, the coil-like main spring 140 and the bias spring 150 are used as elastic members to form the composite protective component, but the present invention is not limited thereto. Thus, the main spring 140 or/and the bias spring 150 may be a spring formed in a shape other than the coil such as a flat spring.

In the above-described embodiments, a power source is connected to the second lead terminal 120, and an electric/electronic device such as a circuit is connected to the first lead terminal 110, but the power source may be connected to the first lead terminal 110 and the electric/electronic device may be connected to the second lead terminal 120.

The surge may be protected by the fuse resistor and the positive temperature coefficient thermistor 700 and the overcurrent may be protected by the repeatable fuse, and the positive temperature coefficient thermistor 700 may additionally latch up a tube current even during a failure of the repeatable fuse, thereby implementing a more stable and reliable surge and overcurrent protection component.

In the composite protective component having the above-described structure, the positive temperature coefficient thermistor and the repeatable fuse may be connected in parallel, and then the fuse resistor may be combined therewith in series, thereby achieving more stable composite protection.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A composite protective component, comprising:
a fuse resistor including a wire resistor; and
a repeatable fuse connected in series with the fuse resistor,
wherein the repeatable fuse includes
a first lead terminal disposed on one side of a housing having an inner space,
an insulation stator configured to fix a part of the first lead terminal while surrounding the part of the first lead terminal,
a spindle disposed inside the housing and electrically connected to a bias spring so as to be electrically connected to or separated from the first lead terminal,
a main spring provided between the first lead terminal and the spindle so as to separate the first lead terminal and the spindle, and
a bias spring provided so as to be connected to the spindle on an opposite side of a direction in which the main spring is positioned with respect to the spindle and configured to electrically connect and separate the first lead terminal and the spindle, and
wherein a second lead terminal is provided so as to be electrically connected to the wire resistor, and the wire resistor is electrically connected to the housing or the bias spring.

2-12. (canceled)

13. The composite protective component of claim 1, wherein the spindle has a tack type structure including a rod-like pin which extends lengthwise as a portion connected to the first lead terminal and a plate-like head which is provided at one end of the pin so as to spread widthwise as a portion connected to the bias spring, or a structure including a rod-like pin which extends lengthwise as the portion connected to the first lead terminal and a convex head on which the bias spring is seated.

14. The composite protective component of claim 1, wherein
the main spring is made of a shape-memory alloy and electrically insulated from the first lead terminal,
the bias spring includes a conductive spring,
when an overcurrent that is greater than a reference value is applied so that an internal temperature of the housing is higher than a transformation temperature of the shape-memory alloy, the tensile force of the main spring is greater than a tensile force of the bias spring so that the spindle is moved to separate the first lead terminal and the spindle from each other, and
when the positive temperature coefficient thermistor is cooled due to disappearance of a cause of the overcurrent or an external overheat source, the tensile force of the main spring is smaller than the tensile force of the bias spring so that the spindle is pressurized to be moved in a direction of the first lead terminal by the tensile force of the bias spring.

15. The composite protective component of claim 1, wherein the housing is an insulating housing, and the wire resistor is provided so as to be wound on an outer peripheral surface of the insulating housing.

16. The composite protective component of claim 7, wherein the wire resistor is electrically connected to the bias spring through a first conductive capsule, and the first conductive capsule is disposed so as to seal one side of the insulating housing and further includes an insulating resin that covers the wire resistor.

17. The composite protective component of claim 1, wherein
the fuse resistor and the repeatable fuse are disposed in parallel to be packaged with an insulating resin,
the housing is a conductive housing or an insulating housing, and
the fuse resistor is electrically connected to the bias spring through a connection terminal or electrically connected to the conductive housing through the connection terminal.

18. The composite protective component of claim 9, wherein the fuse resistor includes
a body,
a wire resistor configured to wind around an outer periphery of the body,
a first conductive capsule electrically connected to the wire resistor and disposed on one side of the body, and
a second conductive capsule electrically connected to the wire resistor and disposed on the other side of the body,
wherein the second lead terminal is disposed on one side of the body and electrically connected to the wire resistor through the second conductive capsule, and the wire resistor is covered by an insulating resin.

19. A composite protective component comprising:
a positive temperature coefficient thermistor;
a repeatable fuse disposed in parallel in the positive temperature coefficient thermistor; and
a fuse resistor electrically connected in series to the positive temperature coefficient thermistor and the repeatable fuse,
wherein the positive temperature coefficient thermistor includes
a positive temperature coefficient element formed in a cylinder or tube shape extended in a longitudinal direction while having an inner space, and an electric resistance of which increases when a temperature of the positive temperature coefficient element is higher than a specific critical temperature,
a first electrode formed at a first side surface of the positive temperature coefficient element, and
a second electrode formed at a second side surface of the positive temperature coefficient element,
wherein the repeatable fuse provided inside the positive temperature coefficient element includes
a first lead terminal disposed on one side of the positive temperature coefficient element having the inner space,
an insulation stator configured to fix a part of the first lead terminal while surrounding the part of the first lead terminal and prevent the first lead terminal from being connected to the positive temperature coefficient element,
a spindle disposed in the positive temperature coefficient element and electrically connected to a bias spring so as to be electrically connected to or separated from the first lead terminal,
a main spring provided between the first lead terminal and the spindle so as to separate the first lead terminal and the spindle, and
a bias spring provided so as to be connected to the spindle on an opposite side of a direction in which the main spring is positioned with respect to the spindle and configured to electrically connect and separate the first lead terminal and the spindle,
wherein the fuse resistor includes
a first conductive capsule electrically connected to the first electrode,
a wire resistor electrically connected to the first conductive capsule, and
a second conductive capsule electrically connected to the wire resistor, and
wherein a second lead terminal is provided so as to be electrically connected to the wire resistor, when an overcurrent higher than a reference value is applied to the positive temperature coefficient thermistor so that the temperature of the positive temperature coefficient thermistor is higher than the specific critical temperature, the electric resistance of the positive temperature coefficient thermistor increases, the main spring expands, and the spindle is moved by a tensile force of the main spring to be separated from the first lead terminal, so that a current flow between the second lead terminal and the first lead terminal is shut off, and when the overcurrent disappears, the positive temperature coefficient thermistor is cooled, and the main spring returns to a normal state in such a manner that the spindle is moved to be electrically connected to the first lead terminal due to a reduction in the tensile force of the main spring.

20. The composite protective component of claim 2, wherein the spindle has a tack type structure including a rod-like pin which extends lengthwise as a portion connected to the first lead terminal and a plate-like head which is provided at one end of the pin so as to spread widthwise as a portion connected to the bias spring, or a structure including a rod-like pin which extends lengthwise as the portion connected to the first lead terminal and a convex head on which the bias spring is seated.

21. The composite protective component of claim 2, wherein
the main spring is made of a shape-memory alloy and electrically insulated from the first lead terminal,
the bias spring includes a conductive spring,
when an overcurrent that is greater than a reference value is applied so that an internal temperature of the housing is higher than a transformation temperature of the shape-memory alloy, the tensile force of the main spring is greater than a tensile force of the bias spring so that the spindle is moved to separate the first lead terminal and the spindle from each other, and
when the positive temperature coefficient thermistor is cooled due to disappearance of a cause of the overcurrent or an external overheat source, the tensile force of the main spring is smaller than the tensile force of the bias spring so that the spindle is pressurized to be moved in a direction of the first lead terminal by the tensile force of the bias spring.

22. The composite protective component of claim 2, wherein the positive temperature coefficient element is made of a BaTiO₃-based ceramic material or a polymeric material obtained in such a manner that metal particles having conductivity are distributed within a polymer matrix.

23. The composite protective component of claim 2, wherein the wire resistor is provided so as to wind around an outer periphery of an insulating resin that covers the second electrode, and the first conductive capsule is disposed so as to seal one side of the insulating housing and further includes an insulating resin that covers the wire resistor.
